(19) United States
(12) Patent Application Publication
(10) Pub. No.: US 2022/0269781 A1
(43) Pub. Date: Aug. 25, 2022

(54) Intelligent Friction for Authentication Methods and Systems

(71) Applicant: Deep Labs Inc., San Francisco, CA (US)

(72) Inventors: Theodore HARRIS, San Francisco, CA (US); Jiri NOVAK, Mill Valley, CA (US); Scott EDINGTON, Arlington, VA (US)

(21) Appl. No.: 17/677,892

(22) Filed: Feb. 22, 2022

Related U.S. Application Data
(60) Provisional application No. 63/151,355, filed on Feb. 19, 2021.

(51) Int. Cl. G06F 21/55; G06F 21/31; G06F 3/0481; H04L 9/40

(52) U.S. Cl. CPC G06F 21/554; G06F 21/316; G06F 3/0481; H04L 63/1491

(57) ABSTRACT

A system and a method for providing intelligent friction by receiving user information based on an interaction of a user with a user interface; and providing intelligent friction through the user interface using an intelligent system. This may comprise changing the user interface relative to a baseline based on the user information. Intelligent friction may provide changes to the user interface. The system may increase security and prevent unauthorized access by bad actors. The system may be less susceptible to hacking by altering how verification or authentication is performed. Systems using intelligent friction may be easily implemented because they may be less reliant on user devices. Rather than requiring multiple communication channels as may be the case in multi-factor authentication, intelligent friction may be advantageously carried out with the user using mobile devices of low complexity.

### CROSS REFERENCE TO RELATED APPLICATIONS

This application claims the benefit of priority to U.S. Provisional Application No. 63/151,355 filed on Feb. 19, 2021, the contents of which is herein incorporated by reference in its entirety.

### TECHNICAL FIELD

The present disclosure generally relates to the fields of authentication using machine learning and artificial intelligence, and in particular to systems and methods for providing adaptive feedback or other responses in user interfaces based on machine learning and artificial intelligence analysis of user behavior.

### BACKGROUND

Streamlined login and onboarding procedures have compressed the time required for machine learning (ML) and artificial intelligence (AI) based systems, among other tools, to accurately identify security threats. For example, ML/AI tools are growing increasingly capable of identifying fraudsters, bots, and household fraud (e.g., situations where an individual within a household poses as other members of the household and logs in or performs other online activities without their knowledge). But at the same time, capabilities of bad actors are also increasing due to advancements in ML/AI.

While streamlined login provides added convenience for end users, it has exposed users and companies to increased risk that could have been mitigated at the time of login. Usually, there is a compromise between user convenience and security. Although systems like two-step or multi-factor authentication can greatly increase security, many users find such systems irritating, inefficient, and can be overly resource-intensive (e.g., requiring a user to maintain multiple computing devices and use multiple communication channels). Furthermore, some comparative methods, such as CAPTCHA tests for a user to demonstrate that he or she is not a robot, have grown increasingly difficult due to advancements in capabilities of bad actors, and can be extremely frustrating for users to solve.

Machine-human interfaces have traditionally focused on overt means of communication. But other methods of communication, such as by subtle, non-intrusive means, have remained untapped. Improvements are desired in systems in methods for providing adaptive feedback or other responses in user interfaces based on machine learning and artificial intelligence analysis of user behavior. For example, when an AI detects an issue with a communication, there is a need for a tool to enable the AI to guide the user to alternative, better outcomes, without disrupting the communication stream.

### SUMMARY

Embodiments of the present disclosure may include technological improvements as solutions to one or more technical problems in conventional systems discussed herein as recognized by the inventors. In view of the foregoing, some embodiments discussed herein may provide systems and methods for providing adaptive feedback or other responses in user interfaces based on machine learning and artificial intelligence analysis of user behavior.

In one embodiment, a method for providing intelligent friction in a user interface system is disclosed. A method may include the steps of: providing intelligent friction by receiving user information based on an interaction of a user with a user interface; and providing intelligent friction through the user interface using an intelligent system. The providing of intelligent friction may comprise changing the user interface relative to a baseline based on the user information.

In accordance with some embodiments, intelligent friction may be injected at critical points in an interaction process in a user interface. An intelligent machine-human interface may be provided that adapts to user behavior to reduce security risks and the potential for fraud by altering user interfaces and work flows to guide users to a desired outcome. Such systems or methods may help to discourage fraud, mitigate impulsive behavior, reduce family or household fraud, and detect and block bots or other automated systems. In some embodiments, systems may be used to accelerate a current course if the outcome is deemed desirable. Intelligent friction may enable a user interface system with AI that communicates with a user in a more subtle and unobtrusive manner as compared to conventional user interface systems. Authentication methods and systems may be enhanced by injecting intelligent friction.

Further objects and advantages of the disclosed embodiments will be set forth in part in the following description, and in part will be apparent from the description, or may be learned by practice of the embodiments. Some objects and advantages of the disclosed embodiments may be realized and attained by the elements and combinations set forth in the claims. However, embodiments of the present disclosure are not necessarily required to achieve such exemplary objects or advantages, and some embodiments may not achieve any of the stated objects or advantages.

It is to be understood that both the foregoing general description and the following detailed description are exemplary and explanatory only and are not restrictive of the disclosed embodiments, as may be claimed.

### BRIEF DESCRIPTION OF DRAWINGS

FIG. 1 is a diagrammatic representation of a user interface system, consistent with embodiments of the present disclosure.

FIGS. 2A-2D are diagrammatic representations of a sign up process, consistent with embodiments of the present disclosure.

FIG. 3 is a diagrammatic representation of a user input process, consistent with embodiments of the present disclosure.

FIGS. 4A-4D are diagrammatic representations of applying intelligent friction during a video game, consistent with embodiments of the present disclosure.

FIG. 5 is a diagrammatic representation of a shopping interaction process, consistent with embodiments of the present disclosure.

FIG. 6 is a diagrammatic representation of a cloud system interface, consistent with embodiments of the present disclosure.

FIG. 7 is a diagrammatic representation of a hive communication system, consistent with embodiments of the present disclosure.

FIG. 8 is a diagrammatic representation of an action plan based on session persona data, consistent with embodiments of the present disclosure.

FIGS. 9-13 are diagrammatic representations of a flow for providing intelligent friction, consistent with embodiments of the present disclosure.

FIG. 14 is a diagrammatic representation of a flow for providing initial profiling models, consistent with embodiments of the present disclosure.

FIG. 15 is a diagrammatic representation of a flow for building and rebuilding dynamic action plans, consistent with embodiments of the present disclosure.

FIG. 16 is a diagrammatic representation of a proactive action plan, consistent with embodiments of the present disclosure.

FIG. 17 is a diagrammatic representation of a communication protocol for providing intelligent friction, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention.

Instead, they are merely examples of apparatuses and methods consistent with aspects related to subject matter described herein.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

Intelligent friction may refer to a technique used with an adaptive machine-human interface to change the user interface in certain ways relative to a baseline. Intelligent friction may be configured to reduce behavior that may constitute a security risk or fraud (e.g., identity fraud in an authentication process). Intelligent friction may be applied using advanced machine learning (ML) or artificial intelligence (AI) to profile users based on their interactions with the interface. For example, individuals may be profiled based on their activities performed on a website, analysis of network data, or external event monitoring. ML/AI systems or methods, such as a deep learning neural network, may be used to gather user information.

A ML/AI tier may continuously track user activities and may predict the user's next interaction and most probable outcome of the current interaction. Such predictions may be based on prior outcome data or unsupervised modeling. In some embodiments, modeling may use Bayesian techniques to update prior assumptions.

Based on a user's predicted path and outcomes, a system may assess whether to initiate intelligent friction. Intelligent friction may be used to, e.g., 1) accelerate the current path (e.g., provide an enhancement relative to a baseline); 2) discourage completion of the interaction (e.g., hamper the user's interaction by providing an impediment relative to the baseline); or 3) guide the interaction to a more desirable outcome.

A planning tier may determine an action plan based on probable next user interactions to guide the user from the current trajectory to a desired outcome. For example, if a user is determined not to be a bad actor, the user may be guided toward a certain outcome in a more streamlined fashion. Aspects of the user interface may be enhanced to allow the user to reach an end goal with less resistance. The design of a website may be altered so that steps leading to completion of a process are emphasized, while distractions (e.g., ads or extraneous material) are de-emphasized. To influence the user's behavior, intelligent friction may be used to guide the user to a certain outcome. The action plan may provide a system action in response to a user interaction. The action plan may provide various system actions to use in response to a particular user interaction. The action plan may comprise a decision tree. There may be multiple branches in the action plan. The action plan may also provide multiple possible system actions to be used in response to one or more user interactions, and the system actions or user interactions may be weighted. Weightings may be based on how effective certain system actions are, or how prevalent certain user interactions are. For example, if it is determined that click speed is highly indicative of whether a user is a bot or not, it may be given higher weight and the system may determine to apply intelligent friction by using an adverse system action to the user (e.g., adding delays to the user's session, or impeding the user's interactions with the user interface in other ways). Weightings may be applied dynamically as more information about the user is gained. Providing weightings may be one example of how a system adapts to a user's sophistication level.

In some embodiments, evolutionary graph learners may be used. Complex systems with numerous actions plans may be mapped out automatically.

Some embodiments may use model-view-controller (MVC) sessions that build on an AI model unique to a certain interaction. Beliefs (e.g., of a particular user) may be shared across a network. A hive mind may be created using shared beliefs.

In some embodiments, a platform may be provided that is generic and can be used to optimize outcomes in different situations, such as: ADA compliance; adapting to different user sophistication levels; adjusting interface during high stress situations; and identification of and neutralization of bots. Particular types of bots may be targeted, such as: bots within a logging environment; bots in social media widgets such as comments sections; and bots within games and other similar platforms.

A system using intelligent friction may present a user with an interface that is adaptable based on user information gathered from the user's interaction with the interface. The system may change certain aspects of the interface to increase security and prevent unauthorized access by bad actors. Intelligent friction may be easily implemented because it may be less reliant on user devices. For example, rather than requiring multiple devices and multiple communication channels as may be the case in multi-factor authentication, intelligent friction may be advantageously carried out with the user using a mobile device of low complexity, while a central server or hive agents provide the bulk of processing power. Intelligent friction may allow a more efficient distribution of resources, as requirements of remote user devices may be relaxed while increased strain (e.g., computing loads) may be shouldered by central servers or agents of a hive mind.

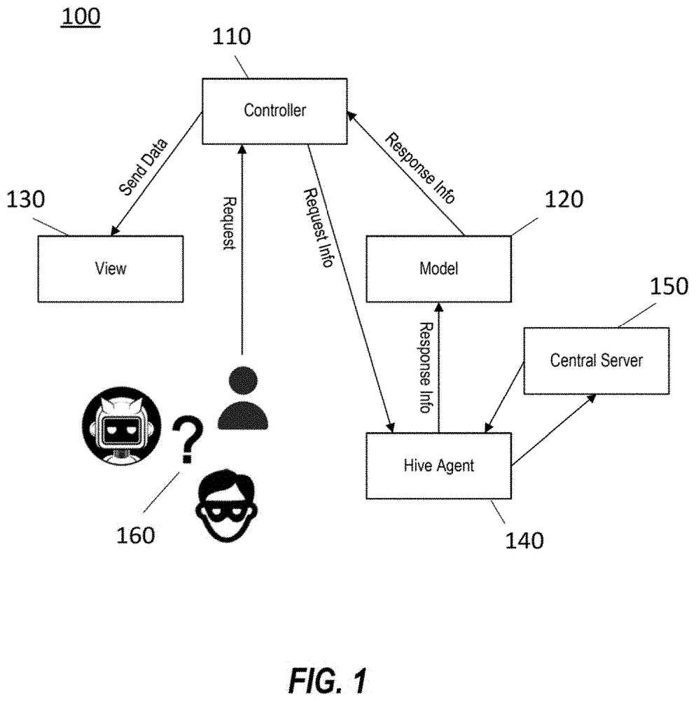

Reference is now made to FIG. 1, which is a diagrammatic representation of a user interface system, consistent with embodiments of the present disclosure. FIG. 1 shows user interface system 100 that includes controller 110, model 120, viewer 130, hive agent 140, central server 150, and a user 160. User interface system 100 may be based on a MVC framework. MVC may refer to a software design pattern that may be used for developing user interfaces. MVC divides related program logic into one of three interconnected elements: model, view, controller. Internal representations of information may be separated from the ways in which the information is presented to and accepted from the user.

User interface system 100 may use an intelligent system, such as Al. For example, hive agent 140 may represent hive mind AI and may be connected to controller 110 and model 120. Thus, user interface system may also be considered an artificial intelligence-MVC (AMVC). Hive agent 140 may have bidirectional communication with central server 150.

Controller 110 may be configured to receive user information. The user information may be input from user 160. User 160 may be a human operator, a robot (e.g., a “bot”), or any operator that provides input to a user interface. The user information may be based on interactions of user 160 with a user interface. User interactions may include use of a scroll wheel (e.g., of a mouse or track pad of a computer), typing (e.g., on a keyboard or virtual keyboard), use of a copy-paste function (e.g., inputting text by a method other than typing each individual letter), click speed (e.g., of a mouse, or tapping in the case of a touch-based user interface), device settings, deletions (e.g., a negative change in text data, such as removing text that has already been input), and interaction time (e.g., the time between finishing one action and the next, such as the delay between finishing text input and clicking the “next”! “submit”/“done” button or similar), or any input of data from the user to the user interface.

Intelligent friction may be used to configure customizable activities that may invite different results based on the actor. For example, user 160 may include a bot, fraudster, or user that is likely to violate terms of service. Activities may be configured such that solutions to the activities are different depending on the actor. A bot may be more likely to commit malicious behavior, while a fraudster may be more likely to commit theft, while some users may be more likely to provide nonsensical or un-useful information (e.g., trolling). User information may describe the type of actor. A system may adapt to the level of sophistication of the user. For example, if it is determined that a user is an advanced bot using advanced methods of attacking the system, the system may respond with more intelligent friction measures that hinder the bot.

Intelligent friction may be used to provide a broad range of responses based on user information. For example, intelligent friction may be applied so as to delay bots and bad actors to tie up their resources. Intelligent friction may be used to block (partially or completely) access to a resource (e.g., a website). Intelligent friction may be used to force a user to pause and reconsider an action or be made aware they are being monitored.

A user interface system using intelligent friction may enable the ability to gain an understanding of a session to, e.g., understand the nature of an event; handle marginal cases where the user is an unknown persona; or reroute the user to alternative systems such as traps or “honeypots.”

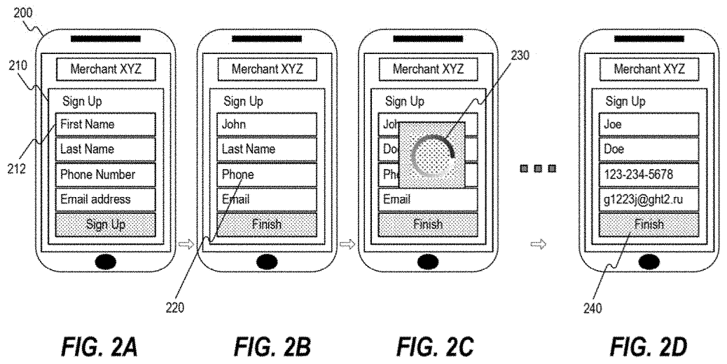

Reference is now made to FIGS. 2A-2D, which are diagrammatic representations of a sign up process, consistent with embodiments of the present disclosure. FIG. 2A shows a terminal 200 having a graphical user interface 210 displayed thereon. Terminal 200 may be a mobile communication device, such as a cell phone, PDA, tablet, or any personal computing device. A user may interact with terminal 200 via a touch screen. Terminal 200 may be configured to provide a user interface via graphical user interface 210. Graphical user interface 210 includes text entry box 212. Graphical user interface 210 may represent a baseline to which intelligent friction may be applied. When no determination is made based on user information, graphical user interface 210 may remain unchanged relative to the baseline, and authentication methods, such as login or sign up operations, may proceed unchanged. When intelligent friction is applied, graphical user interface 210 may undergo changes relative to the baseline. A system using intelligent friction may provide a user interface configured to receive user input data on a terminal. The system (e.g., system 100 discussed above with reference to FIG. 1) may provide graphical user interface 210 on terminal 200.

Intelligent friction may use the layout and navigation of a user interface to modify user behavior. The user interface may include a plurality of input sections. As shown in FIG. 2A, graphical user interface 210 includes a text input box for “First name,” “Last name,” “Phone Number,” and “Email address.” Graphical user interface 210 may be an example of a sign up page for a service.

Intelligent friction may adjust a parameter of the user interface. The parameter may include speed, arrangement of design elements of the user interface, information that has already been input by the user, or any information that affects the user's experience with the user interface. For example, intelligent friction may change various attributes of elements of the user interface. Adjustments to parameters of the user interface may influence the user in certain ways. Arrangement of design elements may be changed. Intelligent friction may move or alter critical buttons or design elements, such as input boxes, buttons, or any element that a user is able to interact with. As an example, intelligent friction may alter the shape, size, or color of design elements. In some embodiments, the parameter may include information that has already been input by the user, such as text the user has already input into text entry boxes. A user's data may be reset by intelligent friction, forcing them to re-enter information they had already input into a text entry box. Further, intelligent friction may alter or extend Terms of Services. The user may be required to agree to new Terms of Service. Alternatively, delays may be injected at critical moments. Some features may be disabled, such as copy-paste. Providing disruptions to users may influence their behavior and may impede bad actors.

In some embodiments, a delay may be added if a phone number is copy-pasted into the user interface. The delay may halt additional text entry. In some embodiments, a copy-paste function may be disabled for certain text entry boxes, such as email addresses. Auto-complete may be disabled. Upon pressing a button signaling completion (e.g., “Sign up now”), data may be reset and the user may be forced to re-enter some or all data. Further, alternative methods of login may be hidden (e.g., the option to sign up using a linked social account). In some embodiments, if the user is determined not to be a bad actor, the user may be encouraged to use alternative methods of login (e.g., by highlighting that option) to streamline the process and make it easier for the genuine user to achieve a certain outcome (e.g., successful registration or sign up).

In some embodiments, parameters of the user interface may include speed of the user interface. For example, the performance speed of the website accessed by the user may be changed. If a user is determined to be a bad actor, less resources may be devoted to that user. The website may be made artificially slow to hamper the bad actor's progress. On the other hand, if a user is determined not to be a bad actor, certain aspects of the user interface may be streamlined so as to allow the user to proceed more easily. This may allow users who are not deemed to be bad actors to access resources using less complex devices. Thus, a bot that may be driven by a complex supercomputer (which may be running multiple bots) may have a more frustrating experience authenticating with a website as compared to a genuine user that is accessing the website from a less complex device, such as an early generation cell phone.

As shown in FIGS. 2A-D, a sign up process may include iterative steps and may be designed to segment users based on user information, such as the user's situation, goals, or personality. In FIG. 2A, a system may start determining a risk level based on device and network data before the user begins typing. As shown in FIG. 2B, the user may begin typing (e.g., entering the first name “John”). At this time, as the user types, the system may collect data such as click speed and transmit the data for analysis (e.g., at a central server). Data may be collected by an application programming interface (API). The system may use AI to analyze the data. As shown in FIG. 2A, friction element 220 may be added. Friction element 220 may include changes to the user interface, such as aesthetic changes to some of the text entry boxes, and changes to the labels of text entry boxes. Such changes may be minor and may not significantly affect a human operator, but may confuse a bot. For example, changing the label of “Phone Number” to “Phone” or simply “number” may cause a bot to misinterpret those text entry steps. However, a human may be able to understand based on context.

As shown in FIG. 2C, the system may add a friction element 230. Friction element 230 may include a delay. Friction element 230 may be used both to add intelligent friction and to obtain further information. If the system detects a threat, or if the model is indeterminate, the system may send a user interface change request based on the threat type. Friction element 230 may be used to gauge the user's response. For example, if the user becomes restless while waiting through the delay, attempting to click other portions of the user interface, or attempt other interactions, the system may determine the user is human and may lower the threat level. However, if abnormal behavior is detected, such as rapidly starting multiple new parallel sessions during the delay, the threat level may be determined to be high.

As shown in FIG. 2D, the system may determine the threat level to pass a threshold and may determine that the user is a bad actor. Once the system is certain a bad actor is involved, the system may halt operation or put the session into an endless delay. Alternatively, additional questions may be added to the sign in process. As shown in FIG. 2D, a completion element 240 may be blocked. Thus, even though a bad actor may be able to input text, the bad actor will be prevented from reaching the outcome of completing registration or signing up.

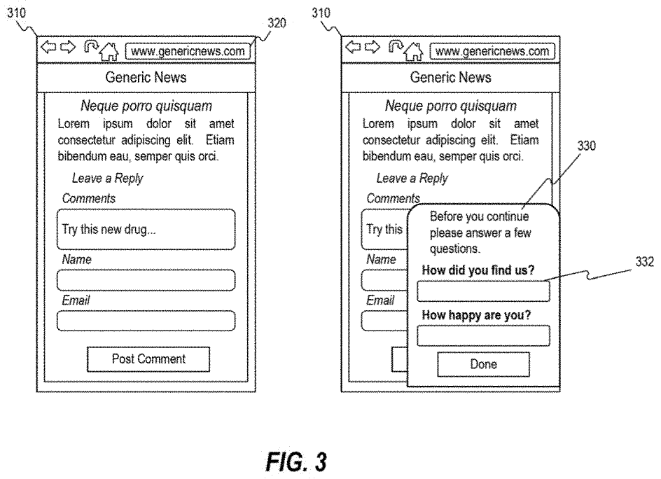

Reference is now made to FIG. 3, which is a diagrammatic representation of a user input process, consistent with embodiments of the present disclosure. FIG. 3 shows a graphical user interface 310. Graphical user interface 310 may include a social media widget, such as a comments section. The social media widget may allow the user to provide user input. Intelligent friction may be used to add an additional questionnaire before the user is able to enter user input for the social media widget.

Adaptive questionnaires may be used to gain additional knowledge of an event. For example, the system may seek to understand the nature of an event by running specially crafted questions for bots, bad actors, or others. The system may seek to handle marginal cases involving an unknown persona. A script may attempt to gain additional information to confirm its initial estimation or assumption. For example, a questionnaire may be provided that asks the user “how did you find the site?”; “are you satisfied?”; “how would you rank this site?”; or “how is the weather?”

As shown in FIG. 3, when a site is visited with intelligent friction installed, the framework may begin analysis by profiling the visit and looking at the IP address and screen interactions. Graphical user interface 310 may include comment posting widget 320. As the user enters or attempts to enter text into widget 320, the system may run analysis on the input text or other user information, such as session data.

The persona of the session may be determined, and if the current persona matches that of a bad actor, such as a bot or human violating the terms of service, the system may trigger adding friction element 330. Friction element 330 may include an additional questionnaire, including questions 332. The additional questionnaire may be used both to discourage bad actors from proceeding and to gain an understanding of the event.

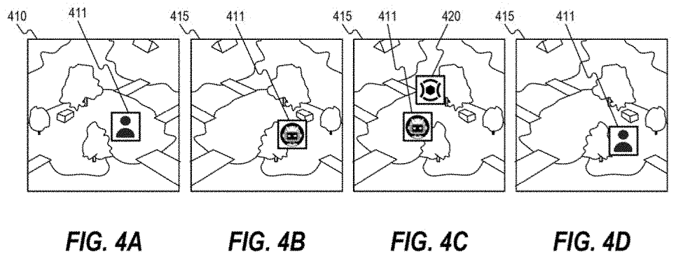

Reference is now made to FIGS. 4A-4D, which are diagrammatic representations of applying intelligent friction during a video game, consistent with embodiments of the present disclosure. FIG. 4A shows a game screen 410 that may be an example of a user interface, consistent with embodiments of the present disclosure. Game screen 410 includes player avatar 411. Player avatar 411 may represent the user.

In a game environment, an intelligent friction API may be installed and may detect bad actors, such as bots. The intelligent friction API may be configured to run adversarial scripts against bad actors to meet certain final objectives (e.g., causing the bad actor to abandon the game).

As shown in FIGS. 4A-4D, certain user interaction may be detectable by a system using intelligent friction. The system may determine that the user in engaging in abnormal behavior. Intelligent friction may be used to alter aspects of the game. The game platform may scan user behavior and may determine if a logged-in user's persona has changed from a human to bot. Abnormal behavior may also include using cheats, running assist programs, or engaging in gameplay not intended by the game creators. If a user is engaging in abnormal behavior, the gaming environment may change key aspects of the game. For example, as shown in FIG. 4B, in game screen 415, the map may be flipped to hamper the bot's actions. In some embodiments, an alternative item may be provided to the user. The alternative item may be something that is different from that provided to users that are not determined to be bad actors. The alternative item may be a trap or honeypot. As shown in FIG. 4C, a honeypot 420 may be generated that acts to confuse the bot. A final objective of the system may be to have the user switch the bot off or abandon the game. As shown in FIG. 4D, as an example of a desired outcome, the user may revert back to human from bot. Then, changes in the user interface may also revert (e.g., changing the map back to the original orientation).

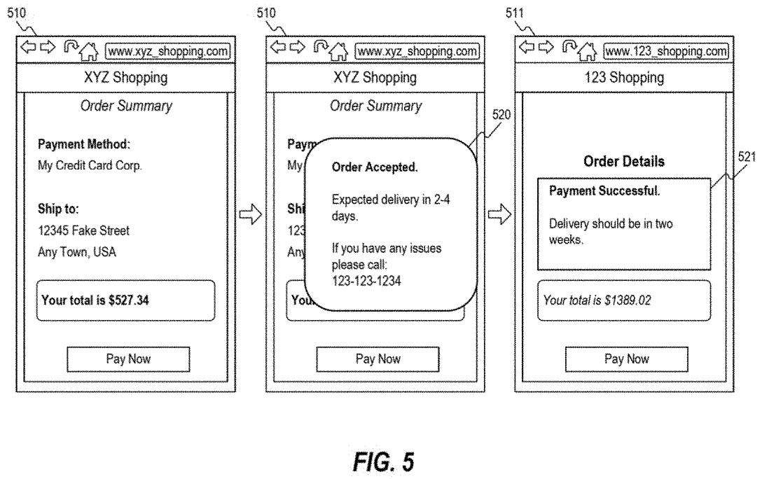

Reference is now made to FIG. 5, which is a diagrammatic representation of a shopping interaction process, consistent with embodiments of the present disclosure. FIG. 5 may represent a shopping situation. A shopping situation may involve a terminal that includes a point of sale device. In some embodiments, shopping may be done online. In some embodiments, shopping may be done at a self-checkout terminal in a physical store.

As shown in FIG. 5, there may be provided a user interface 510. User interface 510 may be associated with an online shop. In a shopping process, intelligent friction may allow bad actors to continue through until checkout, collecting data and gaining a better understanding of the user's ambitions. The system may then add friction element 520. Friction element 520 may include an alternative item. Friction element 520 may include a fake confirmation. The fake confirmation may lead the bad actor to believe that they have successfully placed an order. Thus, the bad actor may then stop attacking the target. In some embodiments, the system may deny the order directly, or may display an error message showing the bad actor that their attempt was unsuccessful. The system may also send a cancellation message separately.

In some embodiments, a hive mind may be used to adapt to new patterns and track users. The system may track users across different locations. The different locations may include different shops or websites. As shown in FIG. 5, there may be a different site having user interface 511 associated with a different online shop from that of user interface 510. Friction element 521 may be provided that includes a “Payment Successful” message. Friction element 521 may appear as though an order was accepted, however, if the user is determined to be a bad actor, the system may deny the order directly or send a cancellation message. Intelligent friction may lead bad actors to believe they have successfully placed a bogus order and may then move onto a new target. When the bot moves on to the next site, the next site may be prepared due to the hive mind's knowledge sharing capability, and may quickly steer the bot to checkout where the bot will place a bogus order and receive a fake confirmation. Fake checkouts may delay and frustrate fraudsters, whereas outright blocking transactions may lead bad actors to try again and they may ultimately be successful.

In some embodiments, terminals may be provided in physical stores. The terminal may be a point of sale device, such as a self-checkout kiosk. Physical stores may gather user information based on the user's physical activity in the store. Intelligent friction may use various external signals such as videos to help determine threat levels in various payment and sign-in situations. For example, at a self-checkout kiosk, a system using intelligent friction may gather user information at a point of checkout, including payment information and video information. Using this data, the system may estimate the user's threat level. Based on the threat level, the system may provide intelligent friction. The intelligent friction may include an alternative item. The alternative item may include a request for repeating an interaction. For example, the system may ask the user to repeatedly try the same payment card to prevent the user from cycling through payment methods. If the user repeats the cycle several times, the kiosk may be locked to prevent the user from using other payment cards. The system may cause the user to repeat checkout interactions. For example, the user may be asked to repeatedly scan an item. The user may realize that he or she is under increased scrutiny and may be discouraged from engaging in abnormal behavior.

Furthermore, similar to how a hive mind may enable different websites to share knowledge, a system using intelligent friction may be deployed within the same environment to enable all payment and identification systems to share knowledge. In some embodiments, the system may not identify a person as a bad actor from prior information. The system may only track a user once the terminal (e.g., kiosk) has determined the user to be high risk. The tracking process may not identify the person but may instead run a traceroute on every object that was in front of the kiosk. The system may use the facility's surveillance systems and may identify bad actors and then shut down terminals they are operating. The system may share tuned algorithms with other terminals within the facility. As the bad actor moves through the facility, he or she may be tracked by surveillance tools and all payment methods and associated terminals may be shut down as they approach.

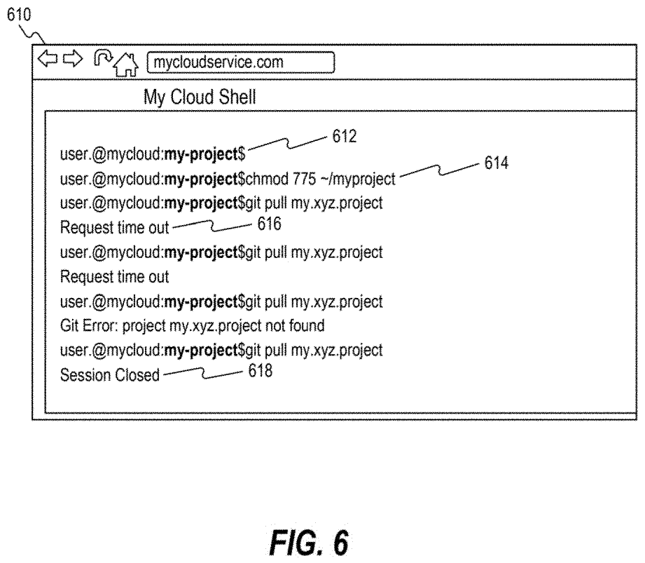

Reference is now made to FIG. 6, which is a diagrammatic representation of a cloud system interface, consistent with embodiments of the present disclosure. FIG. 6 shows a cloud interface 610. Cloud interface 610 reflects several informational or functional elements. For example, there may be provided element 612 that represents when a user first logs in and behaves as though they have in prior sessions. Element 612 may also represent that the user logged in with the correct credentials. There may be provided element 614 that represents intelligent friction monitoring of user activity to see if actions shift to an estimated threat level. There may be provided element 616 that represents if a user's behavior rises to an elevated threat level passing a threshold, then triggering intelligent friction to be injected. There may be provided element 618 that represents that the user's activity is continuously assessed until a predetermined number of interactions is reached, after which the user's session may be closed.

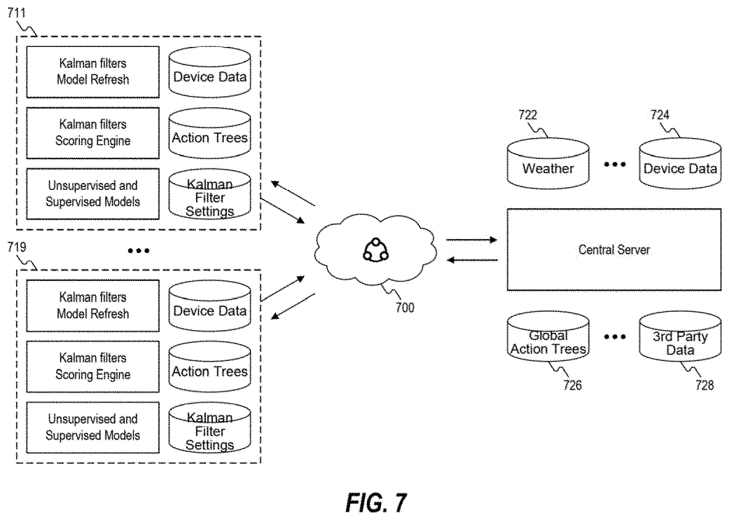

Reference is now made to FIG. 7, which is a diagrammatic representation of a hive communication system, consistent with embodiments of the present disclosure. FIG. 7 shows a network 700 that is connected to various elements. There may be provided a local hive agent 711. Local hive agent 711 may be one of a plurality of hive agents. For example, there may be an arbitrary number of local hive agents up to the n^{th} local hive agent 719. There may also be provided a central server 720. Central server 720 may communicate with various databases or knowledge sources, such as a weather database 722, device database 724, global action plans 726, and third party data 728. A system using intelligent friction may adapt a user interface to guide interactions with a user to a desired outcome. Each session may have a separate Kalman filter that combines various models for a final decision. Session agents may tune the Kalman filter to the current user and may share data in real time with other agents. Each agent may share its new settings via central server 720. Central server 720 may perform analysis based on information received. Central server 720 may filter out weak settings and may consolidate useful information to provide feedback to other agents. Central server 720 may employ Al to create models to predict outcomes, consolidate network signals, and create new action plans based on prior outcomes.

In some embodiments, central server 720 may determine that the hive mind could be degrading or have other issues and may send out alerts to reset all Kalman filter settings. Central server 720 may use AI to run: risk analysis on user profiles when users have made a complaint; and natural language processing (NLP) to determine central issues (e.g., the system may determine a threat level and issue, and may look up an action to take such as: ignore, issue temporary reset, or order Kalman filter setting reset). A user's interaction may be passed on to central server 720. Central server 720 may provide a chat bot to chat with the user. The system may kick out a user who enters a complaint to the chat bot.

In some embodiments, a system using intelligent friction may use an action plan. The action plan may include multiple branches accounting for various possible behaviors of the user and various possible outcomes (e.g., an action tree). The action plan may be associated with a particular user interface. The system may determine to provide intelligent friction according to an action plan. The action plan may be determined based on user information (e.g., the user's interactions with the user interface, or other information such as device/user profile). There may be multiple action plans.

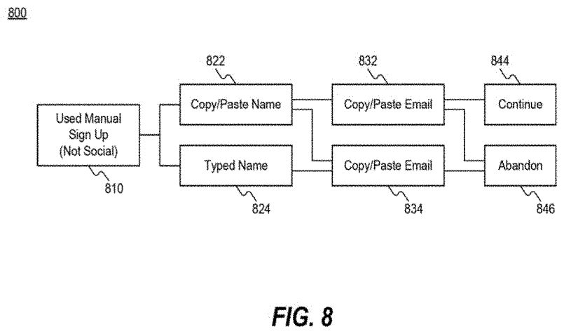

Reference is now made to FIG. 8, which is a diagrammatic representation of an action plan based on session persona data, consistent with embodiments of the present disclosure. FIG. 8 shows action plan 800. Action plan 800 may be constructed based on user information. The user information may include session persona that may be made from combining user profiles, device profiles, user behavior, or other user actions.

Device profiles are typically static during a session and may be collected at the initiation of monitoring. Device profiles may include information such as: factory settings, mismatched language, regional settings that do not match the region where the user interface is hosted, or any information that may be indicative of a suspicious device operating in a particular environment. User profiles may include information such as: not logged in, no social cookies, signed in using public WiFi, or any information that may be indicative of a suspicious user accessing a particular user interface. Other user information may include time series data. The time series data may be based on user interactions (e.g., use of scroll wheel, copy-paste, click speed, device settings, deletions, and interaction time).

An action plan may provide a series of rules for applying intelligent friction in various scenarios with various types of users. User actions may be compared to predefined action plans. The structure of action plans may contain alternative paths and predicted future outcomes.

In action plan 800, a plan for applying intelligent friction to a user may proceed as follows. There may be an element 810 where it is determined that a user has used a manual sign up (e.g., the user did not login via an alternative method such as a linked social profile). Next, action plan 800 may divide into different branches. There may be an element 822 indicating that the user copy-pasted his or her name into a text entry box. Alternatively, there may be an element 824 indicating that the user typed his or her name, letter by letter. If the user repeatedly copy-pastes information into text entry boxes (e.g., 822 to 832), it may be determined that the user will continue to do so. Thus, it may be predicted with at least a certain level of confidence that the user will continue to copy-paste information. The user's predicted action may be to continue, as in element 844. Or, based on other information, such as the user's click speed, it may be determined that the user will give up and abandon the interaction with the user interface, as in element 846. Furthermore, this may be used to determine that the user is likely a certain type of user. Based on the determination that the user is a certain type of user (e.g., a bot), action plan 800 may dictate that certain action should be taken (e.g., providing intelligent friction).

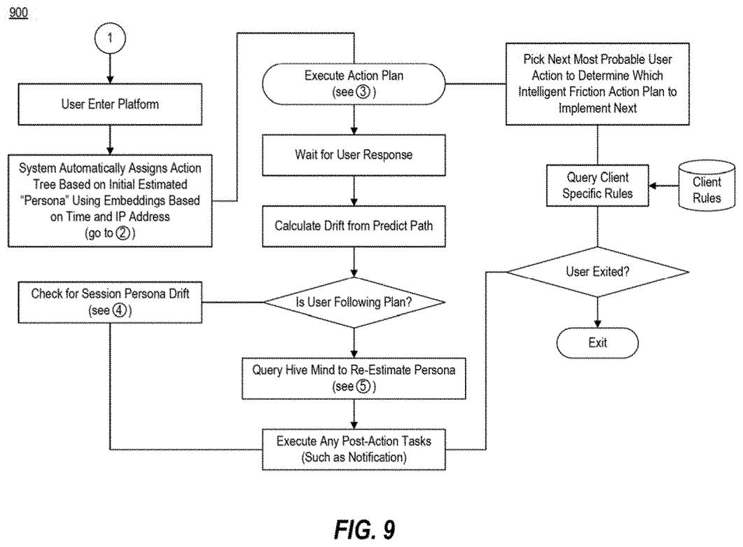

Reference is now made to FIGS. 9-13, which are examples of diagrammatic representations of a flow for providing intelligent friction, consistent with embodiments of the present disclosure. Each session in a system using intelligent friction may include its own AI learner. The AI learner may build upon its interactions with users and may share knowledge within the system (e.g., creating a hive mind). Processes may be used to gather more data for models if the AI learner has an indeterminate score value, for example.

As shown in FIG. 9, an example of a flow for providing intelligent friction may begin with a user entering a platform (e.g., a website or online game). A system for providing a user interface to a user may be configured to provide intelligent friction. At the outset, the system may automatically assign an action plan (e.g., an action tree) based on an initial estimated persona. The persona may represent the user, the session, or various other aspects about the user or session. User information, as determined by the system, may encompass the persona of the user. The user information may be determined using embedded information (e.g., time and IP address).

Next, an action plan may be executed. After executing the action plan, the system may wait for user response and then re-evaluate. Also, the system may determine next probable user actions. Probable future actions of the user may be used to determine which intelligent friction action plan to implement next. The next action plan may also be based on client specific rules, which may be queried from various sources. If at any point the user has exited the platform, the flow may end.

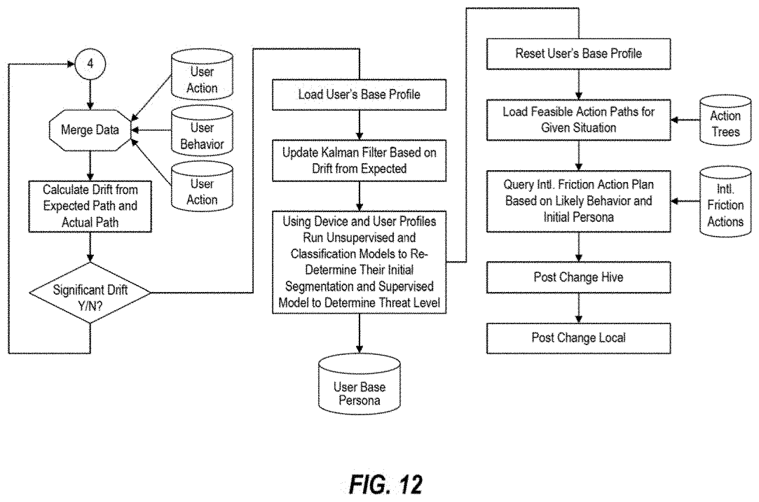

In some embodiments, it may be determined whether the user is following the action plan determined by the system. The system may check for session persona drift (see FIG. 12). Also, the hive mind may be queried to re-estimate the persona. Post action tasks (e.g., actions after the initial application of intelligent friction) may be executed, such as notifications to the user.

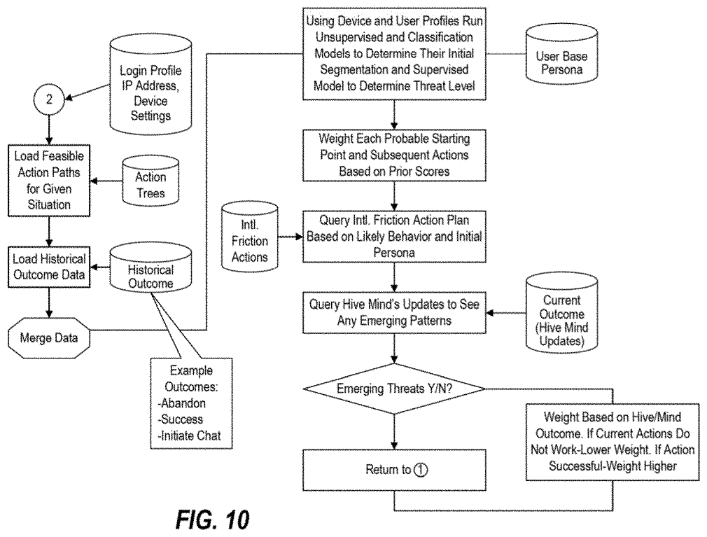

At various points as shown in the general flow of FIG. 9, the flow may proceed to other flowcharts, such as those represented in FIGS. 10-13.

As shown in the example depicted in FIG. 10, a system may automatically assign an action plan or tree based on an initial estimated session persona using embedded information relating to, e.g., time, IP address, login profile, or device settings. Next, the system may load feasible action plans for a given situation. A determination of feasible action plans may take into account stored action plans. The system may also load historical outcome data (e.g., exemplary outcomes of abandonment, success, initiation of chat sessions, and statistics about those outcomes). The system may merge data and then, using device and user profiles, run AI modules such as unsupervised and classification modules to determine initial segmentation of users. The supervised model may determine threat levels. AI modules may draw on databases of user persona. The AI modules may also alter databases information based on information gathered.

In some embodiments, each probable starting point in an action plan may be weighted, as well as subsequent actions based on prior scores. Initial intelligent friction action plans may be queried based on likely behavior and initial persona. Also, hive mind updates may be queried to determine whether any patterns are emerging. If there are emerging threats, action plans may be updated to adjust weights. For example, if current actions are ineffective at deterring bad actor behavior, they may be given lower weight. Whereas, if an action is successful, its weight may be increased.

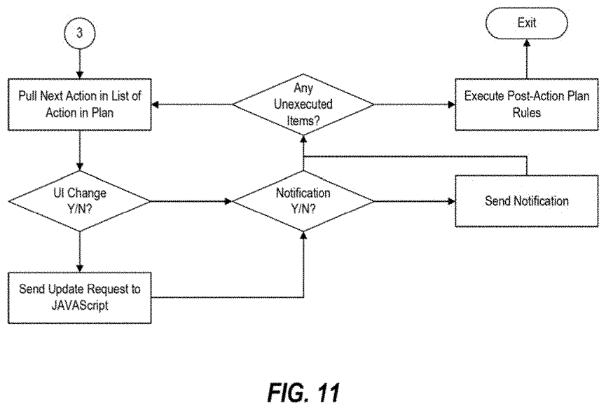

As shown in the example depicted in FIG. 11, an action plan may be executed and intelligent friction may be applied. After an initial action is used (e.g., from an initial action plan), a next action may be pulled from a list in the same or a different action plan. If there are changes in the user interface presented to the user, the system may or may not present the user with a notification. Also, the system may send an update request to auxiliary systems such as JavaScript. If there are unexecuted items, the system may execute post action plan rules.

As shown in the example depicted in FIG. 12, the system may check for session persona drift. In some embodiments, it may be determined that the user is drifting and appropriate action may be taken. For example, data including current user action, user behavior, and other user action may be merged. Drift may be calculated based on an expected path and an actual path. If there is a significant difference between expected and actual path, further action may be taken. Whether a difference is “significant” or not may be based on statistical measures, such as a 95% confidence interval, or other levels of confidence as may be determined to be appropriate in certain instances. Further actions may include loading a user's base profile. In some embodiments, Kalman filters may be updated based on drift from the expected path.

At certain points, initial segmentation (e.g., determination of who is a bad actor, bot, fraudster, etc. vs. a genuine human user) may be redetermined using device and user profiles, or other information. Unsupervised models and classifiers may be used to redetermine segmentation. Further, AI models (e.g., a supervised model) may be used to determine a threat level.

At certain points, a user's base profile may be reset. Then, the system may load feasible action paths for a given situation, which may be based on action plans. The system may also query initial intelligent friction action plans based on likely behavior and initial persona. Then, the system may perform post-changes via hive agents or locally.

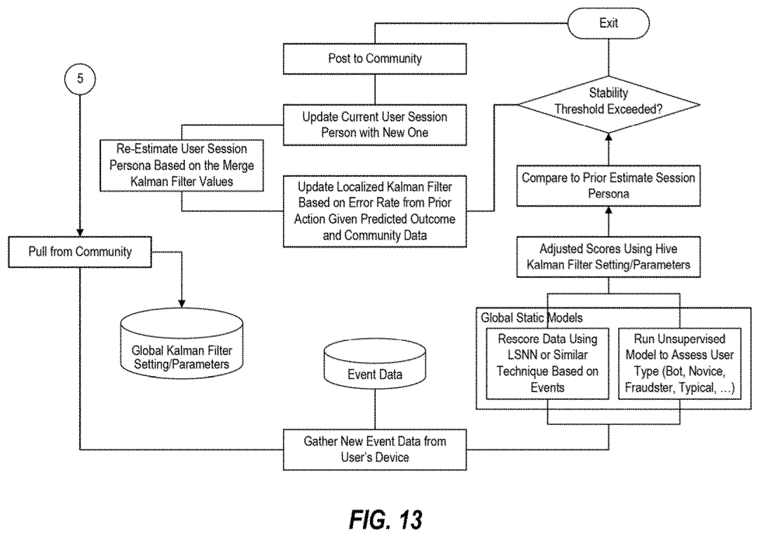

As shown in the example depicted in FIG. 13, hive knowledge may be applied and a persona may be re-estimated based on hive mind results. Hive knowledge may be drawn from community information, such as global Kalman filter settings or parameters. The system may gather new event data from user devices. The system may generate or load stored global static models. The system may use static models to rescore data using LSNN or other neural network methods. The system may run unsupervised models to assess user type (e.g., bot, novice, fraudster, typical user, etc.). The system may compare prior estimates (e.g., prior assumptions or “priors”) based on adjusted scores using hive Kalman filter settings or parameters. If stability passes a certain threshold, the flow may exit. If not, localized Kalman filters may be updated based on error rate from prior actions. Updates may be based on predicted outcomes and community data. Then, the system may re-estimate user session persona data based on merged Kalman filter values. The current user session may be updated, and the system may post information to a community.

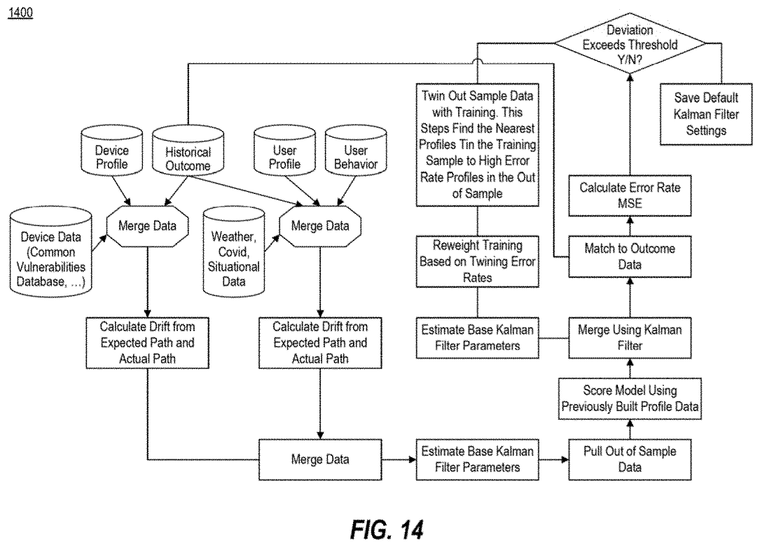

Reference is now made to the example depicted in FIG. 14, which provides a diagrammatic representation of a flow for providing initial profiling models, consistent with embodiments of the present disclosure. Models may be built independently and combined using a Kalman filter to determine a final action. In a step of generating steps based on prior action trees, the system may set a goal such as “filling in the blanks” from a heuristically or statistically derived set of action trees. An intelligent system (e.g., AI module) may use these to extrapolate new rules focusing on desired outcomes.

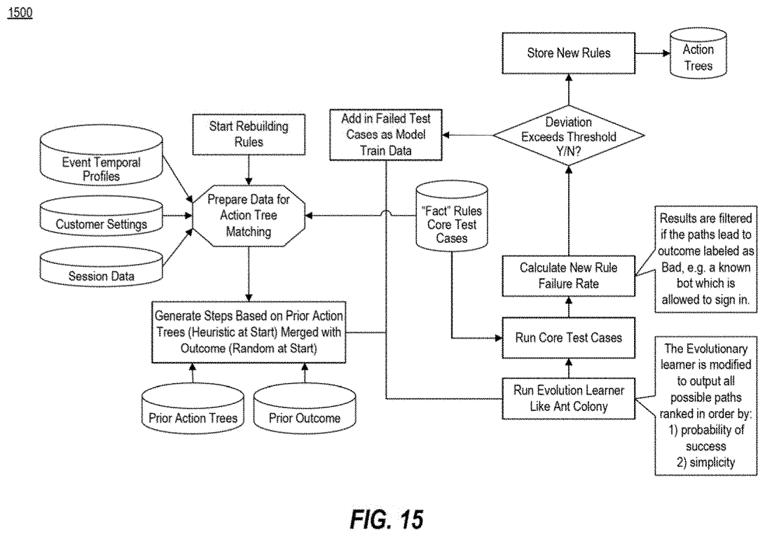

Reference is now made to the example depicted in FIG. 15, which is a diagrammatic representation of a flow for building and rebuilding dynamic action plans, consistent with embodiments of the present disclosure. An action plan or action tree may be built using an evolutionary graph learner (e.g., Ant Colony). A system may enable creation of a voluminous action tree database based on minimal input data.

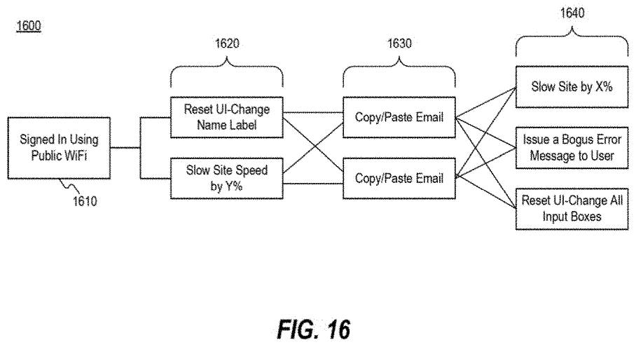

Reference is now made to the example depicted in FIG. 16, which is a diagrammatic representation of a proactive action plan, consistent with embodiments of the present disclosure. A proactive action plan may have alternative steps mapped out based on a user's probably action. FIG. 16 shows an action plan 1600. Some elements of action plan 1600 may be user actions or external events. Some elements of action plan 1600 may be elements determined by system agents. System agent actions may include application of intelligent friction. As an example of a user action, action plan 1600 may include an element 1610 indicating that a user has signed in using public WiFi. As an example of action by system agents, there may be elements 1620 indicating that user interface information has been reset (e.g., change name label), or that the site speed has been slowed by Y%. In reaction to those elements, the user may then perform further interactions, as in elements 1630, such as copy-pasting information into text boxes. Action plan 1600 may provide further actions that may be determined based on user information, such as: prior use action, threat level based on user actions (click speed, etc.), or in some cases randomness to enable learning.

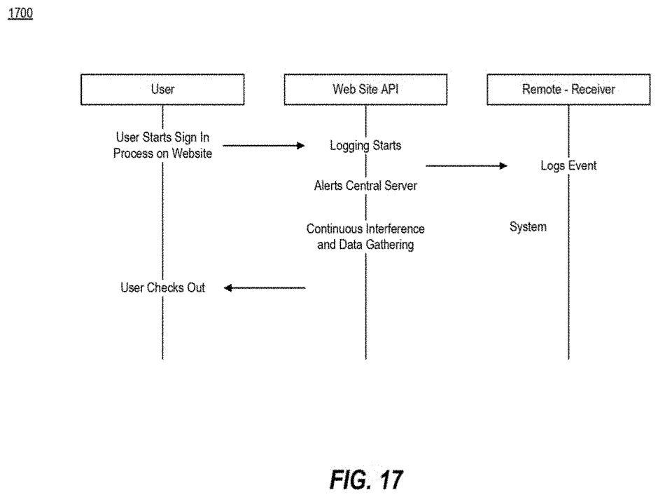

Reference is now made to FIG. 17, which is a diagrammatic representation of a communication protocol for providing intelligent friction, consistent with embodiments of the present disclosure.

Block diagrams in the figures may illustrate the architecture, functionality, and operation of possible implementations of systems, methods, and computer hardware or software products according to various exemplary embodiments of the present disclosure. In this regard, each block in a schematic diagram may represent certain arithmetical or logical operation processing that may be implemented using hardware such as an electronic circuit. Blocks may also represent a module, segment, or portion of code that comprises one or more executable instructions for implementing the specified logical functions. It should be understood that in some alternative implementations, functions indicated in a block may occur out of the order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein.

The embodiments may further be described using the following clauses:
1. A computer-implemented method, comprising:
receiving user information based on an interaction of a user with a user interface; and
   providing intelligent friction through the user interface using an intelligent system,
   wherein providing intelligent friction comprises changing the user interface relative to a baseline based on the user information.
2. The method of clause 1, further comprising:
   providing the user interface configured to receive user input data on a terminal.
3. The method of clause 1 or clause 2, wherein providing intelligent friction further comprises:
   determining an action plan based on the user information.
4. The method of clause 3, wherein the action plan is one of a plurality of action plans determined based on the user information.
5. The method of any one of clauses 1-4, wherein the user information is determined based on a probable next interaction of the user.
6. The method of any one of clauses 1-5, wherein the interaction with the user interface includes at least one of: use of scroll wheel, typing, copy-paste, click speed, device settings, deletions, and interaction time.
7. The method of any one of clauses 1-6, wherein the user information includes a threat level, and wherein providing intelligent friction is based on the threat level relative to a threshold.
8. The method of any one of clauses 1-7, further comprising:
   continuously assessing the user information until a predetermined number of interactions is reached.
9. The method of any one of clauses 1-8, wherein providing intelligent friction further comprises:
   terminating a session of the user interface.
10. The method of any one of clauses 1-9, wherein providing intelligent friction further comprises:
   providing a notification to the user.
11. The method of any one of clauses 1-10, wherein providing intelligent friction further comprises:
   providing an alternative item to the user.
12. The method of clause 11, wherein the alternative item includes a honeypot.
13. The method of clause 11, wherein the alternative item includes a cancellation of a request of the user.
14. The method of clause 11, wherein the alternative item includes a fake confirmation.
15. The method of clause 11, wherein the alternative item includes a request for repeating an interaction.
16. The method of any one of clauses 1-15, wherein providing intelligent friction further comprises:
   adjusting a parameter of the user interface.
17. The method of clause 16, wherein the parameter includes speed.
18. The method of clause 16, wherein the parameter includes arrangement of design elements of the user interface.
19. The method of clause 16, wherein the parameter includes information that has already been input by the user.
20. The method of any one of clauses 1-19, wherein the user interface includes a social media widget.
21. The method of clause 20, wherein the social media widget includes comments.
22. The method of any one of clauses 1-21, wherein the user interface includes a video game.
23. The method of any one of clauses 1-21, wherein the user interface is a graphical user interface.
24. The method of any one of clauses 1-23, wherein the terminal includes a point of sale device.
25. The method of any one of clauses 1-23, wherein the terminal includes an API.
26. The method of any one of clauses 1-25, wherein the intelligent system is configured to adjust to a sophistication level of the user.
27. The method of any one of clauses 1-26, further comprising:

providing the user information to another entity of a network.
28. The method of any one of clauses 1-27, further comprising:

providing an initial profile model.
29. The method of clause 3, wherein the action plan comprises a system action in response to the user information.
30. The method of clause 29, wherein the action plan comprises weightings for the system action or the user information.
31. The method of clause 3, wherein the action plan comprises a decision tree including system actions to apply in response to each of a plurality of user interactions.
32. A controller comprising:
   a processor; and
   a storage communicatively coupled to the processor, wherein the processor is configured to execute programmed instructions stored in the storage to:
   receiving user information based on an interaction of a user with a user interface; and
   providing intelligent friction through the user interface using an intelligent system.
33. The controller of clause 32, further comprising:
   a terminal configured to provide the user interface to the user.
34. A non-transitory computer readable medium storing a set of instructions that is executable by one or more processors of a user interface system cause a processor of the system to perform a method comprising:
   receiving user information based on an interaction of a user with a user interface; and
   providing intelligent friction through the user interface using an intelligent system.
35. The medium of clause 34, further comprising:
   a terminal configured to provide the user interface to the user.

What is claimed is:

1. A computer-implemented method, comprising:
receiving user information based on an interaction of a user with a user interface; and
providing intelligent friction through the user interface using an intelligent system,
wherein providing intelligent friction comprises changing the user interface relative to a baseline based on the user information.

2. The method of claim 1, further comprising:
providing the user interface configured to receive user input data on a terminal.

3. The method of claim 1, wherein providing intelligent friction further comprises:
determining an action plan based on the user information.

4. The method of claim 3, wherein the action plan is one of a plurality of action plans determined based on the user information.

5. The method of claim 1, wherein the user information is determined based on a probable next interaction of the user.

6. The method of claim 1, wherein the interaction with the user interface includes at least one of: use of scroll wheel, typing, copy-paste, click speed, device settings, deletions, and interaction time.

7. The method of claim 1, wherein the user information includes a threat level, and wherein providing intelligent friction is based on the threat level relative to a threshold.

8. The method of claim 1, further comprising:
continuously assessing the user information until a predetermined number of interactions is reached.

9. The method of claim 1, wherein providing intelligent friction further comprises:
terminating a session of the user interface;
providing a notification to the user; or
providing an alternative item to the user.

10. The method of claim 9, wherein the alternative item includes a honeypot; a cancellation of a request of the user; a fake confirmation; or a request for repeating an interaction.

11. The method of claim 1, wherein providing intelligent friction further comprises:
adjusting a parameter of the user interface.

12. The method of claim 11, wherein the parameter includes speed; arrangement of design elements of the user interface; or information that has already been input by the user.

13. The method of claim 1, wherein the intelligent system is configured to adjust to a sophistication level of the user.

14. The method of claim 1, further comprising:
providing the user information to another entity of a network.

15. The method of claim 3, wherein the action plan comprises a system action in response to the user information.

16. The method of claim 15, wherein the action plan comprises weightings for the system action or the user information.

17. The method of claim 3, wherein the action plan comprises a decision tree including system actions to apply in response to each of a plurality of user interactions.

18. A controller comprising:
a processor; and
a storage communicatively coupled to the processor, wherein the processor is configured to execute programmed instructions stored in the storage to:
receiving user information based on an interaction of a user with a user interface; and
providing intelligent friction through the user interface using an intelligent system,
wherein providing intelligent friction comprises changing the user interface relative to a baseline based on the user information.

19. The controller of claim 18, further comprising:
a terminal configured to provide the user interface to the user.

20. A non-transitory computer readable medium storing a set of instructions that is executable by one or more processors of a user interface system cause a processor of the system to perform a method comprising:
receiving user information based on an interaction of a user with a user interface; and
providing intelligent friction through the user interface using an intelligent system,
wherein providing intelligent friction comprises changing the user interface relative to a baseline based on the user information.
